(19) United States
(12) Patent Application Publication
(10) Pub. No.: US 2024/0391011 A1
(43) Pub. Date: Nov. 28, 2024

(54) MULTIFUNCTIONAL DIGITAL PULSE ELECTRIC WELDING MACHINE SYSTEM

(71) Applicant: WeldMart Inc., Charleston, SC (US)

(72) Inventor: Xiaofeng YE, wenzhou (CN)

(21) Appl. No.: 18/797,436

(22) Filed: Aug. 7, 2024

(51) Int. Cl. B23K 9/095; B23K 9/09

(52) U.S. Cl. CPC B23K 9/0953; B23K 9/09

(57) ABSTRACT

Disclosed is a multi-functional digital pulse electric welding machine system, which comprises an LCD interactive platform, an MCU control module, a wire feeder and an inverter main circuit, the LCD interactive platform is connected to the MCU control module, and is a man-machine interactive operation platform, an input end of the inverter main circuit is connected to a commercial power input and an output end of the inverter main circuit outputs a direct current to provide for a welding torch of an electric welding machine, the MCU control module is connected to the inverter main circuit and the wire feeder, and the MCU control module controls the inverter main circuit and the wire feeder to work according to a working mode selected by the LCD interactive platform.

### TECHNICAL FIELD

The present invention relates to the technical field of electric welding, and particularly to a multi-functional digital pulse electric welding machine system.

### BACKGROUND OF THE PRESENT INVENTION

In current environment, according to the actual welding field, gas shielded welding and alternating/direct current argon arc welding both have selection requirements, and if terminal customers need to meet various functional requirements, they may have to buy multiple welding machines, which will increase application costs. At present, most of the products on the market focus on non-pulse MIG/MAG (gas metal arc welding) models, integrated with direct-current argon arc welding and MMA (manual welding). However, if pulse MIG welding, pulse argon arc welding and pulse MMA are required, there is no corresponding product. Digital control is needed in the control of the integrated multi-functional welding machine above, and the high-speed computation of the MCU can realize quick adjustment and control on the welding machine, so as to respond to a dynamic feedback in the welding process more quickly. Therefore, a new multi-functional digital pulse electric welding machine system is invented.

### SUMMARY OF THE PRESENT INVENTION

The object of the present invention is to provide a multi-functional digital pulse electric welding machine system, in which a new multi-functional electric welding machine integrates all functions of MIG welding, TIG welding (argon tungsten-arc welding) and MMA welding, and each mode has a pulse welding mode.

The object of the present invention can be achieved by the following technical measure: a multi-functional digital pulse electric welding machine system is provided, wherein the multi-functional digital pulse electric welding machine system comprises an LCD interactive platform, an MCU control module, a wire feeder and an inverter main circuit, the LCD interactive platform is connected to the MCU control module, and is a man-machine interactive operation platform, an input end of the inverter main circuit is connected to a commercial power input and an output end of the inverter main circuit outputs a direct current to provide for a welding torch of an electric welding machine, the MCU control module is connected to the inverter main circuit and the wire feeder, and the MCU control module controls the inverter main circuit and the wire feeder to work according to a working mode selected by the LCD interactive platform.

The object of the present invention can also be achieved by the following technical measure:

the multi-functional digital pulse electric welding machine system further comprises a protection circuit, the protection circuit collects current and voltage signals of the electric welding machine, and transmits the collected signals to the MCU control module, and the MCU control module judges and processes abnormalities of overcurrent, overvoltage and overheating of the electric welding machine in real time according to the signals collected by the protection circuit.

The wire feeder adopts an electromotive force feedback wire feeder, a wire feed motor of the wire feeder feeds back an electromotive force voltage to the MCU control module, and the MCU control module carries out speed compensation according to the received feedback electromotive force voltage.

The inverter main circuit comprises a bridge rectifier circuit, a filter circuit, an inverter circuit and a half-wave rectifier circuit which are connected in sequence, the bridge rectifier circuit rectifies received commercial power, converts an alternating current into a direct current, and outputs the direct current to the filter circuit, the filter circuit filters the direct current, the inverter circuit inverts the filtered direct current into an alternating current, and the half-wave rectifier circuit rectifies the alternating current, outputs a direct current, and provides the direct current to the welding torch of the electric welding machine.

The inverter main circuit further comprises a voltage and current sampling circuit and an inverter control circuit, the voltage and current sampling circuit is connected to the half-wave rectifier circuit and the MCU control module, the voltage and current sampling circuit collects a current and a voltage output by the half-wave rectifier circuit, and transmits collected output current and voltage signals to the MCU control module, the MCU control module generates a feedback signal to the inverter control circuit according to the voltage and current signals collected by the voltage and current sampling circuit and the electromotive force fed back by the wire feeder, and the inverter control circuit is connected to the inverter circuit, and controls the inverter circuit to work according to the feedback signal.

When the multi-functional digital pulse electric welding machine system is selected to work in an argon arc welding mode through the LCD interactive platform, the MCU control module limits a maximum short-circuit current by controlling a signal of a primary current transformer of an element transformer in the inverter circuit.

When the multi-functional digital pulse electric welding machine system is selected to work in a direct-current argon arc welding mode through the LCD interactive platform, the MCU control module generates a given pulse signal, and carries out PI proportional integral adjustment on the given pulse signal and an output current signal collected by the voltage and current sampling circuit, the inverter circuit controls an alternating current signal transmitted to the half-wave rectifier circuit according to the signal subjected to PI adjustment, so as to control the direct current output by the half-wave rectifier circuit to provide for the welding torch of the electric welding machine, and the MCU control module also controls gas feeding time, an arc striking current, slow rising time, a welding current, a pulse frequency, slow falling time and an arc extinguishing current in an argon arc welding process.

When the multi-functional digital pulse electric welding machine system is selected to work in centralized direct-current gas shielded welding and manual direct-current gas shielded welding modes through the LCD interactive platform, the MCU control module limits a maximum short-circuit current by controlling a signal of a primary current transformer of an element transformer in the inverter circuit; and the MCU control module outputs a control signal to switch to a constant voltage control circuit, the MCU control module gives a given voltage signal and a given wire feed speed signal, collects an output voltage from an output end of the welding machine, and filters the output voltage through a third-order filter to obtain a voltage feedback signal, the feedback signal and the given voltage signal are subjected to PI adjustment through a voltage loop to control a PWM pulse width, so as to obtain a stable output voltage, and the MCU control module gives the given wire feed speed signal to control a rotating speed of the wire feeder to achieve the best welding effect.

When the multi-functional digital pulse electric welding machine system is selected to work in a manual welding mode through the LCD interactive platform, the MCU control module limits a maximum short-circuit current by controlling a signal of a primary current transformer of an element transformer in the inverter circuit; and during working in a direct-current manual welding mode, the MCU control module generates a given pulse signal, and carries out PI proportional integral adjustment on the given pulse signal and an output current signal collected by the voltage and current sampling circuit, and the inverter circuit controls an alternating current signal transmitted to the half-wave rectifier circuit according to the signal subjected to PI adjustment, so as to control the direct current output by the half-wave rectifier circuit to provide for the welding torch of the electric welding machine.

When the multi-functional digital pulse electric welding machine system is selected to work in a pulse MIG mode through the LCD interactive platform, the MCU module, by using a high-speed computing ability of the MCU, controls each globular transfer process, and controls current rising and falling rates of the electric welding machine in short circuit and arc burning, so as to improve the welding efficiency and welding quality.

The LCD interactive platform adopts a 7.0-inch LCD, and carries out data communication with the MCU control module through an RS232 interface.

The MCU control module adopts a GD32E230C8T6 chip.

According to the multi-functional digital pulse electric welding machine system in the present invention, the 7.0-inch LCD interactive platform is adopted, which is more friendly and convenient for a user in experience compared with a previous digital tube scheme, and can display more information; by using the high-speed computing ability of the MCU, the dynamic response of the welding process is greatly improved, each globular transfer process can be accurately controlled, and the current rising and falling rates of the electric welding machine in short circuit and arc burning can be accurately controlled, so as to greatly improve the welding efficiency and welding quality; and various welding modes are integrated, thus being capable of adapting to most welding application scenarios, and greatly solving the problem of use cost of a terminal user.

### DESCRIPTION OF THE DRAWINGS

FIG. 1 is a structural diagram of a specific embodiment of a multi-functional digital pulse electric welding machine system according to the present invention.

### DETAILED DESCRIPTION OF PREFERRED EMBODIMENTS

It should be noted that the following detailed descriptions are all exemplary and are intended to further describe the present invention. Unless otherwise specified, all technical and scientific terms used herein have the same meanings as those commonly understood by those of ordinary skills in the art to which the present invention belongs.

It should be noted that the terms used herein are only used to describe specific embodiments, and are not intended to limit exemplary embodiment according to the present invention. As used herein, the singular form is intended to include the plural form, unless the context clearly indicates otherwise. In addition, it should be further understood that terms “include” and/or “comprise” used in this specification indicate that there are features, steps, operations, and/or combinations thereof.

A multi-functional digital pulse electric welding machine system according to the present invention comprises: an LCD interactive platform, an MCU control module, a wire feeder, an inverter main circuit and a protection circuit. The MCU control module is used as a logic control center, the LCD interactive platform is used as a man-machine interactive operation platform, and the LCD interactive platform is connected to the MCU control module. The MCU control module calculates and feeds back an operating instruction on the LCD interactive platform, and the wire feeder, the inverter main circuit and the protection circuit are all electrically connected with the LCD interactive platform to complete the transmission of an electric signal.

Mode selections of the LCD interactive platform comprise: working in a direct-current MMA mode, working in an alternating-current MMA mode, working in a direct-current TIG mode, working in an alternating-current TIG mode, working in a direct-current MIG mode and working in an SYNMIG (centralized gas shielded welding) mode. Through the above technical solution, the present invention is characterized in the digital electric welding machine control system integrating direct-current MIG/MAG welding, pulse direct-current MIG/MAG welding, direct-current TIG welding, pulse TIG welding, direct-current MMA welding and pulse direct-current MMA welding. An LCD interface operation module is provided with various mode selections, and this function is realized through the MCU control module and its peripheral circuits.

The LCD interface operation module adopts a 7.0-inch LCD, adopts a UI design, and cooperates with an encoder and a key to complete the operation of the whole interactive interface.

A model of the MCU control module is a GD32E230C8T6 chip.

The wire feeder adopts an electromotive force feedback wire feeder, a wire feed motor of the wire feeder feeds back an electromotive force voltage to the MCU control module, and the MCU control module carries out speed compensation through a feedback signal.

The present invention is further set as follows: the inverter main circuit comprises a rectifier bridge, a filter circuit, an inverter control circuit, a full-bridge inverter circuit, an output rectifier and a voltage and current sampling circuit.

The protection circuit comprises a hardware circuit for detecting a current and a voltage of the welding system, and the MCU control module can timely process abnormalities of overcurrent, overvoltage and overheating of the machine through the real-time detection of these protection circuits.

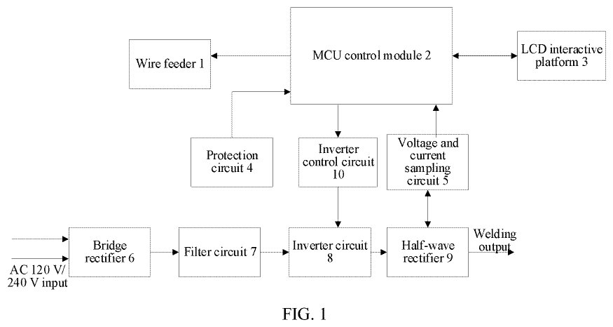

As shown in FIG. 1, FIG. 1 is a structural diagram of the multi-functional digital pulse electric welding machine system according to the present invention. The multi-functional digital electric welding machine comprises a wire feeder 1, an MCU control module 2, an LCD interactive platform 3, a protection circuit 4 and an inverter main circuit.

The LCD interactive platform 3 adopts a 7.0-inch LCD, and carries out data communication with the MCU control module 2 through an RS232 interface.

The inverter main circuit comprises a voltage and current sampling circuit 5, a bridge rectifier circuit 6, a filter circuit 7, an inverter control circuit 10, an inverter circuit 8 and a half-wave rectifier circuit 9. The bridge rectifier circuit 6 rectifies received commercial power, converts an alternating current into a direct current and outputs the direct current to the filter circuit 7, the filter circuit 7 filters the direct current, the inverter circuit 8 inverts the filtered direct current into an alternating current, the half-wave rectifier circuit 9 rectifies the alternating current, outputs a direct current, and provides the direct current to a welding torch of an electric welding machine, and the inverter control circuit 10 receives a signal from the MCU control system 2 to control the inverter circuit 8 to work.

The voltage and current sampling circuit 5 is connected to the half-wave rectifier circuit 9, and the MCU control module 2 is connected to the inverter control circuit to control an IGBT of a full-bridge part to work. The voltage and current sampling circuit 5 comprises output voltage detection and output current detection, and the voltage and current sampling circuit 5 generates the feedback signal to the inverter control circuit according to the feedback voltage and current signals.

The protection circuit 4 collects current and voltages signals from the electric welding machine, and transmits the signals to the MCU control module 2, and the MCU control module 2 can timely process abnormalities of overcurrent, overvoltage and overheating of the machine through the real-time detection of these protection circuits.

In this embodiment, a brand-new 7.0-inch high-resolution LCD is used to replace a traditional digital tube display mode, which can provide customers with a more intuitive interface for operating the welding machine. After the welding machine is turned on, there is a 3-second startup picture before entering the welding machine system. A user may select a mode according to a currently needed mode, set parameters, and get abnormality information through the interface.

The MCU control module comprises a GD32F303RCT6 main control chip. The MCU main control chip is provided with a built-in high-speed analog-to-digital conversion module, and a 2*8 sampling channel responsible for the signal collection of each sampling circuit of the whole machine. The MCU main control chip is provided with a built-in 2-channel high-speed digital-to-analog conversion module. The digital-to-analog conversion chip has high conversion accuracy and a high conversion speed, and can complete the waveform output in the MIG pulse mode in real time and ensure the real output of the waveform.

This system has more than eight functions, which are respectively: centralized short-circuit gas shielded welding, manual short-circuit gas shielded welding, pulse centralize gas shielded welding, pulse manual gas shielded welding, pulse manual welding, direct-current manual welding, pulse argon arc welding, direct-current argon arc welding, and the like. The switching and control of various functions are realized by communication between the LCD interactive platform and the MCU control unit and modulation by the MCU control unit through software design, the various functions share the hardware circuit without adding other additional circuits, and are all realized by software, which greatly simplifies circuit design and manufacture, and realizes a simple structure and a low cost.

During working in argon arc welding, a maximum short-circuit current is limited through a signal of a primary current transformer of an element transformer in the inverter circuit 8.

During working in direct-current argon arc welding, the MCU in the MCU control module 2 and the high-precision high-speed digital-to-analog conversion chip obtain an accurate given pulse signal, then an accurate output current feedback signal is obtained by a high-precision Hall current sensor in the voltage and current sampling circuit 5, and the given signal and the sampled feedback signal are subjected to PI adjustment (proportional integral adjustment) through a high-precision operational amplifier. The inverter control circuit controls a PWM pulse signal through the value subjected to PI adjustment, which can accurately control an output current. Meanwhile, gas feeding time, an arc striking current, slow rising time, a welding current, a pulse frequency, slow falling time and an arc extinguishing current in an argon arc welding process may all be controlled through the MCU control module 2, wherein the pulse frequency can reach 3 KHz due to a high-speed performance of the MCU, thus realizing high-quality welding.

During working in centralized direct-current gas shielded welding and manual direct-current gas shielded welding, a maximum short-circuit current is limited through a signal of a primary current transformer of a transformer in the inverter circuit 8. When the man-machine interactive interface selects centralized direct-current gas shielded welding and manual direct-current gas shielded welding, the MCU control module 2 gives a control signal to switch to a constant voltage control circuit, the MCU gives a given voltage signal and a given wire feed speed signal according to an internal expert parameter database, collects an output voltage from an output end of the welding machine, and filters the output voltage through a third-order filter to obtain an accurate voltage feedback signal, the feedback signal and the given voltage signal are subjected to PI adjustment through a voltage loop to control a PWM pulse width, so as to obtain a stable output voltage. Meanwhile, the high-performance wire feeder is used, the given wire feed speed signal is given by the MCU, and a wire feed control circuit in a hardware part can accurately control a rotating speed of the wire feeder to achieve the best welding effect. During working in manual welding, a maximum short-circuit current is limited through a signal of a primary current transformer of a transformer in the inverter circuit 8. During working in direct-current manual welding, the MCU in the MCU control module 2 and the high-precision high-speed digital-to-analog conversion chip obtain an accurate given pulse signal, then an accurate output current feedback signal is obtained by a high-precision Hall current sensor, and the given signal and the feedback signal are subjected to PI adjustment through a high-precision operational amplifier. The inverter control circuit controls a PWM pulse signal through the value subjected to PI adjustment, which can accurately control an output current. During working in pulse MIG, by using the high-speed computing ability of the MCU, the dynamic response of the welding process is greatly improved, each globular transfer process can be accurately controlled, and the current rising and falling rates of the electric welding machine in short circuit and arc burning can be accurately controlled, so as to greatly improve the welding efficiency and welding quality.

Finally, it should be noted that: the above are only the preferred embodiments of the present invention, and the preferred embodiments are not intended to limit the present invention. Although the present invention is described in detail with reference to the above embodiments, those skilled in the art may still modify the technical solutions recorded in the above embodiments, or make equivalent replacements to some of the technical features. Any modification, equivalent substitution, improvement, etc. made within the spirit and principle of the present invention are included in the scope of protection of the present invention.

Except for the technical features described in the specification, they are all known to those skilled in the art.

We claim:

1. A multi-functional digital pulse electric welding machine system, wherein the multi-functional digital pulse electric welding machine system comprises an LCD interactive platform, an MCU control module, a wire feeder and an inverter main circuit, the LCD interactive platform is connected to the MCU control module, and is a man-machine interactive operation platform, an input end of the inverter main circuit is connected to a commercial power input and an output end of the inverter main circuit outputs a direct current to provide for a welding torch of an electric welding machine, the MCU control module is connected to the inverter main circuit and the wire feeder, and the MCU control module controls the inverter main circuit and the wire feeder to work according to a working mode selected by the LCD interactive platform.

2. The multi-functional digital pulse electric welding machine system according to claim 1, wherein the multi-functional digital pulse electric welding machine system further comprises a protection circuit, the protection circuit collects current and voltage signals of the electric welding machine, and transmits the collected signals to the MCU control module, and the MCU control module judges and processes abnormalities of overcurrent, overvoltage and overheating of the electric welding machine in real time according to the signals collected by the protection circuit.

3. The multi-functional digital pulse electric welding machine system according to claim 1, wherein the wire feeder adopts an electromotive force feedback wire feeder, a wire feed motor of the wire feeder feeds back an electromotive force voltage to the MCU control module, and the MCU control module carries out speed compensation according to the received feedback electromotive force voltage.

4. The multi-functional digital pulse electric welding machine system according to claim 3, wherein the inverter main circuit comprises a bridge rectifier circuit, a filter circuit, an inverter circuit and a half-wave rectifier circuit which are connected in sequence, the bridge rectifier circuit rectifies received commercial power, converts an alternating current into a direct current, and outputs the direct current to the filter circuit, the filter circuit filters the direct current, the inverter circuit inverts the filtered direct current into an alternating current, and the half-wave rectifier circuit rectifies the alternating current, outputs a direct current, and provides the direct current to the welding torch of the electric welding machine.

5. The multi-functional digital pulse electric welding machine system according to claim 4, wherein the inverter main circuit further comprises a voltage and current sampling circuit and an inverter control circuit, the voltage and current sampling circuit is connected to the half-wave rectifier circuit and the MCU control module, the voltage and current sampling circuit collects a current and a voltage output by the half-wave rectifier circuit, and transmits collected output current and voltage signals to the MCU control module, the MCU control module generates a feedback signal to the inverter control circuit according to the voltage and current signals collected by the voltage and current sampling circuit and the electromotive force fed back by the wire feeder, and the inverter control circuit is connected to the inverter circuit, and controls the inverter circuit to work according to the feedback signal.

6. The multi-functional digital pulse electric welding machine system according to claim 5, wherein when the multi-functional digital pulse electric welding machine system is selected to work in an argon arc welding mode through the LCD interactive platform, the MCU control module limits a maximum short-circuit current by controlling a signal of a primary current transformer of an element transformer in the inverter circuit.

7. The multi-functional digital pulse electric welding machine system according to claim 5, wherein when the multi-functional digital pulse electric welding machine system is selected to work in a direct-current argon arc welding mode through the LCD interactive platform, the MCU control module generates a given pulse signal, and carries out PI proportional integral adjustment on the given pulse signal and an output current signal collected by the voltage and current sampling circuit, the inverter circuit controls an alternating current signal transmitted to the half-wave rectifier circuit according to the signal subjected to PI adjustment, so as to control the direct current output by the half-wave rectifier circuit to provide for the welding torch of the electric welding machine, and the MCU control module also controls gas feeding time, an arc striking current, slow rising time, a welding current, a pulse frequency, slow falling time and an arc extinguishing current in an argon arc welding process.

8. The multi-functional digital pulse electric welding machine system according to claim 5, wherein when the multi-functional digital pulse electric welding machine system is selected to work in centralized direct-current gas shielded welding and manual direct-current gas shielded welding modes through the LCD interactive platform, the MCU control module limits a maximum short-circuit current by controlling a signal of a primary current transformer of an element transformer in the inverter circuit; and the MCU control module outputs a control signal to switch to a constant voltage control circuit, the MCU control module gives a given voltage signal and a given wire feed speed signal, collects an output voltage from an output end of the welding machine, and filters the output voltage through a third-order filter to obtain a voltage feedback signal, the feedback signal and the given voltage signal are subjected to PI adjustment through a voltage loop to control a PWM pulse width, so as to obtain a stable output voltage, and the MCU control module gives the given wire feed speed signal to control a rotating speed of the wire feeder to achieve the best welding effect.

9. The multi-functional digital pulse electric welding machine system according to claim 5, wherein when the multi-functional digital pulse electric welding machine system is selected to work in a manual welding mode through the LCD interactive platform, the MCU control module limits a maximum short-circuit current by controlling a signal of a primary current transformer of an element transformer in the inverter circuit; and during working in a direct-current manual welding mode, the MCU control module generates a given pulse signal, and carries out PI proportional integral adjustment on the given pulse signal and an output current signal collected by the voltage and current sampling circuit, and the inverter circuit controls an alternating current signal transmitted to the half-wave rectifier circuit according to the signal subjected to PI adjustment, so as to control the direct current output by the half-wave rectifier circuit to provide for the welding torch of the electric welding machine.

10. The multi-functional digital pulse electric welding machine system according to claim 5, wherein when the multi-functional digital pulse electric welding machine system is selected to work in a pulse MIG mode through the LCD interactive platform, the MCU module, by using a high-speed computing ability of the MCU, controls each globular transfer process, and controls current rising and falling rates of the electric welding machine in short circuit and arc burning, so as to improve the welding efficiency and welding quality.

11. The multi-functional digital pulse electric welding machine system according to claim 1, wherein the LCD interactive platform adopts a 7.0-inch LCD, and carries out data communication with the MCU control module through an RS232 interface.

12. The multi-functional digital pulse electric welding machine system according to claim 1, wherein the MCU control module adopts a GD32E230C8T6 chip.
